(19) United States
(12) Patent Application Publication
(10) Pub. No.: US 2026/0148519 A1
(43) Pub. Date: May 28, 2026

(54) METHOD FOR CONSTRUCTING ADAPTIVE WEIGHT-BASED CROSS-CAMERA PROXY CONTRASTIVE LOSS

(71) Applicants: Qilu University of Technology (Shandong Academy of Sciences), Jinan (CN); Shandong Artificial Intelligence Institute, Jinan (CN)

(72) Inventors: Zhihui LI, Jinan (CN); Ming SHI, Jinan (CN); Wenli HU, Jinan (CN); Jipu MIAO, Jinan (CN); Xiaomin DING, Jinan (CN)

(21) Appl. No.: 19/301,884

(22) Filed: Aug. 15, 2025

(30) Foreign Application Priority Data
Nov. 28, 2024 (CN) 202411720172.6

(51) Int. Cl. G06V 10/44; G06N 3/0464; G06N 3/084; G06T 5/20; G06V 10/42; G06V 10/74; G06V 10/762; G06V 10/771

(52) U.S. Cl. CPC G06V 10/44; G06N 3/0464; G06N 3/084; G06T 5/20; G06V 10/42; G06V 10/761; G06V 10/762; G06V 10/771

(57) ABSTRACT

The disclosure relates to image retrieval, and provides a method for constructing an adaptive weight-based cross-camera proxy contrastive loss; the method includes: obtaining a pre-processed training dataset; inputting the pre-processed training dataset into a convolutional neural network to obtain a global feature; constructing a cross-camera proxy contrastive loss function based on the global feature; constructing an adaptive weight for the cross-camera proxy contrastive loss based on the cross-camera proxy contrastive loss function; training the network with adaptive weight-integrated cross-camera proxy contrastive loss; and optimizing the network by back-propagating an optimized network parameter. With the adaptive weight, the network model realizes adjustment of the contribution of each sample to the loss based on similarities between the samples and the feature centroids of the cameras; a higher weight is assigned to samples with similar features so that the model being trained focuses more on such higher weighted samples.

### FIELD

The present application relates to image retrieval, and more particularly relates to a method for constructing adaptive weight-based cross-camera proxy contrastive loss.

### BACKGROUND

Person re-identification has become a focal task in image retrieval due to rapid advancement in artificial intelligence technologies, which realizes quick and accurate identification by utilizing a person re-identification system for retrieving a single image given. An image library usually includes images captured by multiple cameras.

A same person would have distinct feature representations under different cameras due to inter-camera variations in view angles, light conditions, and backgrounds; such distinctions would increase intra-class variance and thusly degrade identification performance of a person re-identification task. Therefore, it is desirable to introduce cross-camera proxy contrastive loss to alleviate the influence. In traditional contrastive loss, a same weight would be assigned to all samples; however, in cross-camera learning, samples in a same class but from different cameras always differ significantly in terms of similarities.

### SUMMARY

In view of the above, the present application provides a method for constructing adaptive weight-based cross-camera proxy contrastive loss, which can improve learning capacity of a model, adjust contribution of each sample to the loss, and enhance efficiency of feature learning.

In a first aspect of the present application, there is provided a method for constructing adaptive weight-based cross-camera proxy contrastive loss, the method comprising:
Step 1: pre-processing a person image dataset captured from different cameras to obtain a pre-processed training dataset;
Step 2: inputting the pre-processed training dataset into a convolutional neural network to obtain a global feature;
Step 3: constructing a cross-camera proxy contrastive loss function based on the global feature;
Step 4: constructing an adaptive weight for the cross-camera proxy contrastive loss based on the cross-camera proxy contrastive loss function;
Step 5: training the convolutional neural network with adaptive weight-integrated cross-camera proxy contrastive loss, and optimizing the convolutional neural network by back-propagating an optimized network parameter.

Optionally, step 1 comprises:
letting

$$D = {\{ {x}_{i} \}}_{i = 1}^{{N}_{D}}$$

formally represent an unlabeled training dataset, where xᵢ denotes an image and N_{D} denotes the number of images; firstly extracting a feature map represented by F_{θ}(xᵢ)∈ [symbol] ^{C×H×W}, where C, H, and W denote channel size, height, and width of the feature map, respectively; and pre-processing the person image dataset captured, the pre-processing including horizontal flipping, filling, and then cropping.

Optionally, step 2 comprises:
firstly transmitting the pre-processed training dataset to the convolutional neural network, the convolutional neural network comprising a plurality of convolutional layers, activation layers, pooling layers, and fully connected layers;
wherein in the convolutional layers, the network extracts local features in the image by sliding a convolutional kernel to capture visual information of different patches; nonlinearity is added by applying a nonlinear activation function to an output of each convolutional layer operation, thereby enhancing model expressive power; next, in the pooling layers, the network is further down-sampled to reduce dimensions of the feature map, thereby decreasing computation and controlling overfitting; a resulting feature map from multi-layer convolution and pooling operations is flattened into a one-dimension vector and inputted into the fully connected layers to further integrate respective pieces of feature information; a feature vector outputted from the last one of the fully connected layers is a global feature

$${f}_{i}^{g} ,$$

the global feature representing global information of the input image, available for a subsequent person re-identification task.

Optionally, step 3 comprises:
firstly performing cluster analysis on each sample feature in the training dataset and grouping similar features into a same group; obtaining centroid c_{(a,b)} of each group by computing a mean value of all features in the group; then, computing the cross-camera proxy contrastive loss based on the centroids to yield an optimized model, as expressed below:

$${c a m}_{} = - {\sum }_{i = 1}^{{N}_{D}} \frac{1}{\vert {P}_{i} \vert} {\sum }_{j ∈ {P}_{i}} log \frac{exp ( {c}_{j}^{⊤} {f}_{i}^{g} / τ )}{{\sum }_{k ∈ {P}_{i} ⋃ {Q}_{i}} exp ( {c}_{k}^{⊤} {f}_{i}^{g} / τ )} ;$$

where Pᵢ and Qᵢ denote sets of indexes for positive samples and hard negative samples of the global feature

$${f}_{i}^{g} ,$$

respectively;

$${c}_{j}^{⊤}$$

denotes transposition of feature centroid of a camera-aware proxy associated with the positive sample j, which represents a mean value of the features in a same group b under a same camera label a;

$${c}_{k}^{⊤}$$

denotes transposition of the feature centroid of the camera-aware proxy, which represents a centroid associated with the negative sample k; τ denotes a temperature parameter for controlling a smoothness degree in loss computation.

Optionally, step 4 comprises:
constructing an adaptive weight for dynamic ally adjusting the cross-camera proxy contrastive loss, an expression of the adaptive weight being given below:

$${w}_{ij} = \frac{1}{1 + exp ( - α ( \frac{{c}_{j} {f}_{i}^{g}}{‖ {c}_{j} ‖ ‖ {f}_{i}^{g} ‖} - β ) )} ;$$

where

$$\frac{{c}_{j} {f}_{i}^{g}}{‖ {c}_{j} ‖ ‖ {f}_{i}^{g} ‖}$$

represents computation of a cosine similarity for measuring a similarity between the global feature

$${f}_{i}^{g}$$

and the camera centroid cⱼ, a higher value of which indicates a higher sample-centroid similarity; α denotes a temperature parameter for controlling a degree of influence of the similarity on the weight; threshold β denotes an offset amount, which serves to adjust a similarity threshold; finally, a Sigmoid function is applied to ensure that the weight wᵢⱼ falls between (0, 1).

Optionally, step 5 comprises:
integrating the adaptive weight into the cross-camera proxy contrastive loss, expressed as:

$${L}_{final} = {\sum }_{i = 1}^{{N}_{D}} \frac{1}{\vert {P}_{i} \vert} {\sum }_{j ∈ {P}_{i}} {w}_{ij} \cdot ( - log \frac{exp ( {c}_{j}^{⊤} {f}_{i}^{g} / τ )}{{\sum }_{k ∈ {P}_{i} ⋃ {Q}_{i}} exp ( {c}_{k}^{⊤} {f}_{i}^{g} / τ )} ) ;$$

where N_{D} denotes the number of images; Pᵢ and Qᵢ denote sets of indexes for positive samples and hard negative samples of global feature

$${f}_{i}^{g} ,$$

respectively; wᵢⱼ denotes the weight;

$${c}_{j}^{⊤}$$

denotes transposition of the feature centroid of a camera-aware proxy associated with the positive sample j; τ denotes the temperature parameter;

$${c}_{k}^{⊤}$$

denotes transposition of the feature centroid of the camera-aware proxy.

In a second aspect of the present application, there is provided a computer-readable storage medium, comprising a program stored thereon, wherein the program, when being executed, controls the computer-readable storage medium to perform the method for constructing adaptive weight-based cross-camera proxy contrastive loss according to the first aspect or according to any optional implementation of the first aspect.

In a third aspect of the present application, there is provided an electronic device, comprising: one or more processors; a memory; and one or more computer programs, wherein the one or more computer programs are stored in the memory; the one or more computer programs include an instruction which, when being executed by the electronic device, enables the electronic device to perform the method for constructing adaptive weight-based cross-camera proxy contrastive loss according to the first aspect or according to any optional implementation of the first aspect.

In the technical solutions described herein, the method comprises: pre-processing a person image dataset captured from different cameras to obtain a pre-processed training dataset; inputting the pre-processed training dataset into a convolutional neural network to obtain a global feature; constructing a cross-camera proxy contrastive loss function based on the global feature; constructing an adaptive weight for the cross-camera proxy contrastive loss based on the cross-camera proxy contrastive loss function; training the convolutional neural network with adaptive weight-integrated cross-camera proxy contrastive loss; and optimizing the convolutional neural network by back-propagating an optimized network parameter. With the adaptive weight provided by the method, the network model realizes adjustment of the contribution of each sample to the loss based on similarities between the samples and the feature centroid of the cameras; a higher weight is assigned to samples with similar features so that the model being trained focuses more on such higher weighted samples, thereby enhancing feature learning efficiency.

### BRIEF DESCRIPTION OF THE DRAWINGS

To illustrate the technical solutions in the embodiments of the present application more clearly, the accompanying drawings used in the embodiments will be introduced briefly. It is apparent that the accompanying drawings described herein only illustrate some embodiments of the present application; and to a person of normal skill in the art, other drawings may also be derived from these drawings.

FIG. 1 is a flow diagram of a method for constructing adaptive weight-based cross-camera proxy contrastive loss according to some implementations of the present application;

FIG. 2 is a schematic diagram of an electronic device according to some implementations of the present application.

### DETAILED DESCRIPTION OF EMBODIMENTS

To make the objectives, technical solutions, and advantages of the embodiments of the present application more apparent, the technical solutions in the embodiments of the present applications will be described in a clear and comprehensive manner with reference to the accompanying drawings. It is apparent that the embodiments described herein are only some of them, not all of them. All other embodiments derived by a person of normal skill in the art from the embodiments described herein without exercise of inventive work shall fall within the scope of protection of the present application.

It needs to be noted that the embodiments described herein are only some of the embodiments of the present application, not all of them. All other embodiments derived by a person of normal skill in the art from the embodiments described herein without exercise of inventive work shall fall within the scope of protection of the present application.

The terms referred to in the embodiments hereof are intended only for describing specific embodiments, not intended for limiting the present application. The singular form “a/an,” “the,” and “said” as used herein intends for inclusion of a plurality form unless otherwise indicated in the context.

It should be understood that, the term “and/or” referred to therein intends only for describing a relationship between associated objects, which indicates three possible relationships. For example, the term A and/or B may indicate existence of A alone, simultaneous existence of A and B, and existence of B alone. In addition, the character “/” used herein generally indicate an “or” relationship between the associated objects.

The term “if” referred to herein may be interpreted as “when . . . ,” “in a case that . . . ,” “in response to determining that . . . ,” or “in response to detecting that . . . ” dependent on the context. Similarly, the phrase “if it is determined that . . . ” or “if it is detected that . . . (a condition or an event as stated)” may be interpreted as “when it is determined that . . . ,” or “in response to determining that . . . ,” “when it is detected that . . . (a condition or an event as stated),” or “in response to detecting . . . (a condition or an event as stated).”

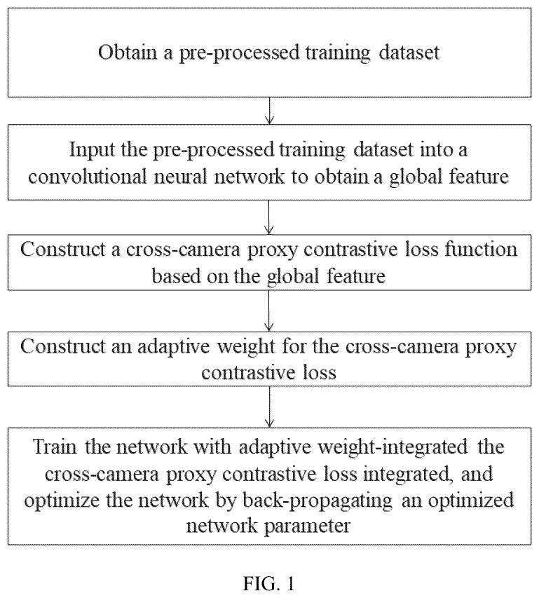

FIG. 1 is a flow diagram of a method for constructing adaptive weight-based cross-camera proxy contrastive loss according to some implementations of the present application. As illustrated in FIG. 1, the method comprises:
Step 1: a person image dataset captured from different cameras is pre-processed to obtain a pre-processed training dataset.

In some implementations of the present application, step 1 comprises:
letting

$$D = {\{ {x}_{i} \}}_{i = 1}^{{N}_{D}}$$

formally represent an unlabeled training dataset, where xᵢ denotes an image and N_{D} denotes the number of images; firstly extracting a feature map represented by F_{θ}(xᵢ)∈ [symbol] ^{C×H×W}, where C, H, and W denote channel size, height, and width of the feature map, respectively; and pre-processing the person image dataset captured, the pre-processing including horizontal flipping, filling, and then cropping.
Step 2: the pre-processed training dataset is inputted into a convolutional neural network to obtain a global feature.

In some implementations of the present application, step 2 comprises:
firstly transmitting the pre-processed training dataset to the convolutional neural network, the convolutional neural network comprising a plurality of convolutional layers, activation layers, pooling layers, and fully connected layers;
wherein in the convolutional layers, the network extracts local features in the image by sliding a convolutional kernel to capture visual information of different patches; nonlinearity is added by applying a nonlinear activation function to an output of each convolutional layer operation, thereby enhancing model expressive power; next, in the pooling layers, the network is further down-sampled to reduce dimensions of the feature map, thereby decreasing computation and controlling overfitting; a resulting feature map from multi-layer convolution and pooling operations is flattened into a one-dimension vector and inputted into the fully connected layers to further integrate respective pieces of feature information; a feature vector outputted from the last one of the fully connected layers is a global feature

$${f}_{i}^{g} ,$$

the global feature representing global information of the input image, available for a subsequent person re-identification task.
Step 3: a cross-camera proxy contrastive loss function is constructed based on the global feature.

In some implementations of the present application, step 3 comprises:
firstly performing cluster analysis on each sample feature in the training dataset and grouping similar features into a same group; obtaining centroid c_{(a,b)} of each group by computing a mean value of all features in the group; then, computing the cross-camera proxy contrastive loss based on the centroids to yield an optimized model, as expressed below:

$${cam}_{} = - {\sum }_{i = 1}^{{N}_{D}} \frac{1}{\vert {P}_{i} \vert} {\sum }_{j ∈ {P}_{i}} log \frac{exp ( {c}_{j}^{⊤} {f}_{i}^{g} / τ )}{{\sum }_{k ∈ {P}_{i} ⋃ {Q}_{i}} exp ( {c}_{k}^{⊤} {f}_{i}^{g} / τ )} ;$$

where Pᵢ and Qᵢ denote sets of indexes for positive samples and hard negative samples of the global feature

$${f}_{i}^{g} ,$$

respectively;

$${c}_{j}^{⊤}$$

denotes transposition of feature centroid of a camera-aware proxy associated with the positive sample j, which represents a mean value of the features in a same group b under a same camera label a;

$${c}_{k}^{⊤}$$

denotes transposition of the feature centroid of the camera-aware proxy, which represents a centroid associated with the negative sample k; τ denotes a temperature parameter for controlling a smoothness degree in loss computation.

In some implementations of the present application, the loss function maps proxies in a same cluster but from different cameras close so as to reduce the intra-class variance due to non-overlapping of camera views.
Step 4: an adaptive weight for the cross-camera proxy contrastive loss is constructed based on the cross-camera proxy contrastive loss function.

In some implementations of the present application, step 4 comprises:
constructing an adaptive weight for dynamically adjusting the cross-camera proxy contrastive loss, an expression of the adaptive weight being given below:

$${w}_{ij} = \frac{1}{1 + exp ( - α ( \frac{{c}_{j} {f}_{i}^{g}}{‖ {c}_{j} ‖ ‖ {f}_{i}^{g} ‖} - β ) )} ;$$

where

$$\frac{{c}_{j} {f}_{i}^{g}}{‖ {c}_{j} ‖ ‖ {f}_{i}^{g} ‖}$$

represents computation of a cosine similarity for measuring a similarity between the global feature

$${f}_{i}^{g}$$

and the camera centroid cⱼ, a higher value of which indicates a higher sample-centroid similarity; α denotes a temperature parameter for controlling a degree of influence of the similarity on the weight; threshold β denotes an offset amount, which serves to adjust a similarity threshold; finally, a Sigmoid function is applied to ensure that the weight wᵢⱼ falls between (0, 1).

In some implementations of the present application, a larger α leads to a higher sensitivity of the weight to change of the similarity so that it can reflect the influence of the similarity on the loss more accurately; when the cosine similarity exceeds β, the weight increases; otherwise, the weight decreases. This may help set a similarity benchmark so that a higher sample similarity is more influential; the Sigmoid function as applied ensures that the weight wᵢⱼ falls between (0, 1) to control contribution of the weight to the loss, resulting in more stable training. The weight wᵢⱼ decreases as the similarity decreases, which reflects that in a case of a lower similarity, the samples from different classes have a diminished influence on the loss, thereby avoiding interference with model training.
Step 5: the network is trained with the adaptive weight-integrated cross-camera proxy contrastive loss, and the network is optimized by back-propagating an optimized network parameter.

In some implementations of the present application, step 5 comprises:
integrating the adaptive weight into the cross-camera proxy contrastive loss, expressed as:

$${L}_{final} = {\sum }_{i = 1}^{{N}_{D}} \frac{1}{\vert {P}_{i} \vert} {\sum }_{j ∈ {P}_{i}} {w}_{ij} \cdot ( - log \frac{exp ( {c}_{j}^{⊤} {f}_{i}^{g} / τ )}{{\sum }_{k ∈ {P}_{i} ⋃ {Q}_{i}} exp ( {c}_{k}^{⊤} {f}_{i}^{g} / τ )} ) ;$$

where N_{D} denotes the number of images; Pᵢ and Qᵢ denote sets of indexes for positive samples and hard negative samples of global feature

$${f}_{i}^{g} ,$$

respectively; wᵢⱼ denotes the weight;

$${c}_{j}^{T}$$

denotes transposition of the feature centroid of a camera-aware proxy associated with the positive sample j; τ denotes the temperature parameter;

$${c}_{k}^{T}$$

denotes transposition of the feature centroid of the camera-aware proxy.

In some implementations of the present application, owing to this adaptive weight setup, the model can have its weight dynamically adjustable based on the inter-sample similarity, so that in a case of a higher similarity, the influence of these similar samples is more focused, while in a case of a lower similarity, the influence of the samples is diminished. This method can not only enhance learning capacity of the model in a cross-camera task, but also can effectively reduce noises brought by different view angles, thereby enhancing the overall performance.

A conventional loss function generally employs a fixed weight, which fails to fully consider similarity differences between various samples, leading to higher noises and increased intra-class variances during the training process. Due to introduction of the adaptive weight, the present application realizes dynamic adjustment of the contribution of each sample to the loss based on inter-feature similarities, thereby reducing interferences from different classes of samples with model training. The present application not only enhances model robustness in cross-camera identification, but also effectively reduces noises due to differences in view angles, further significantly enhancing the overall performance of person re-identification.

The steps in the implementations described supra may be carried out by an electronic device. The electronic device includes, but is not limited to, a mobile phone, a tablet computer, a portable computer, and a desktop computer, etc.

In a technical solution according to the present application, the method comprises: pre-processing a person image dataset captured from different cameras to obtain a pre-processed training dataset; inputting the pre-processed training dataset into a convolutional neural network to obtain a global feature; constructing a cross-camera proxy contrastive loss function based on the global feature; constructing an adaptive weight for the cross-camera proxy contrastive loss based on the cross-camera proxy contrastive loss function; training the convolutional neural network with adaptive weight-integrated cross-camera proxy contrastive loss; and optimizing the convolutional neural network by back-propagating an optimized network parameter. With the adaptive weight provided by the method, the network model realizes adjustment of the contribution of each sample to the loss based on similarities between the samples and the feature centroid of the cameras; a higher weight is assigned to samples with similar features so that the model being trained focuses more on such higher weighted samples, thereby enhancing feature learning efficiency.

In some implementations of the present application, there is provided a computer-readable medium, the computer-readable medium including a program stored thereon; when the program is running, the electronic device where the computer-readable medium is hosted is controlled to execute the implementations of the method for constructing adaptive weight-based cross-camera proxy contrastive loss as described supra.

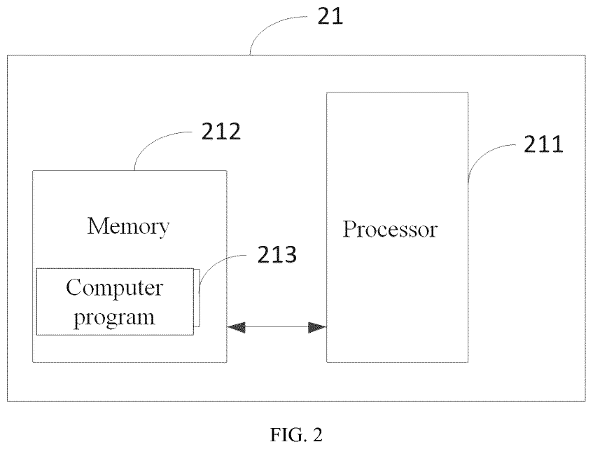

FIG. 2 is a schematic diagram of an electronic device according to some implementations of the present application. As illustrated in FIG. 2, the electronic device 21 comprises: a processor 211, a memory 212, and a computer program 213 stored on the memory and executable by the processor 211, the computer program 213, when being executed by the processor 211, performs the method for constructing adaptive weight-based cross-camera proxy contrastive loss according to the implementations of the present application, which, for the sake of brevity, will not be repeated here.

The electronic device 21 comprises, but is not limited to, a processor 211 and a memory 212. Those skilled in the art would understand that, FIG. 2 only illustrates an example of the electronic device 21, not constituting a limitation thereto; instead, the electronic device may comprise more or less components than what are illustrated, or may have some components combined, or may comprise components different from what are illustrated; for example, the electronic device may further comprise an input/out device, a network access device, or a bus.

The processor 211 referred to herein may be a central processing unit (CPU), or a general processor, a digital signal processor (DSP), an application specific integrated circuit (ASIC), a field programmable gate array (FPGA), or another programmable logic device, or a discrete gate, or a transistor logic device, or a discrete hardware component, etc.; the general processor may be a microprocessor, or any conventional processor, etc.

The memory 212 may be an internal storage unit of the electronic device 21, for example, a hard disk or a random-access memory of the electronic device 21. The memory 212 may also be a storage device external to the electronic device 21, e.g., a plug-in hard disk provided on the electronic device 21, a smart media card (SMC), a secure digital (SD) card, and a flash card, etc. Furthermore, the memory 212 may include both of the internal storage unit of the electronic device 21 and the external storage device. The memory 212 is configurable to store a computer program as well as other programs and data necessary for the network device. The memory 212 may also be configured to store outputted or to-be-outputted data.

Those skilled in the art would clearly understand that, for the sake of a convenient and concise description, the specific operating procedures of the system, apparatus, and units described supra may refer to corresponding processes described in the above-mentioned method implementations, which will not be detailed here.

What have been described are only exemplary implementations of the present application, which are not intended for limiting the present application. Any alteration, equivalent substitution, and modification made within the spirits and principles of the present application shall fall within the scope of protection of the present application.

We claim:

1. A method for constructing adaptive weight-based cross-camera proxy contrastive loss, comprising:
Step 1: pre-processing a person image dataset captured from different cameras to obtain a pre-processed training dataset;
Step 2: inputting the pre-processed training dataset into a convolutional neural network to obtain a global feature;
Step 3: constructing a cross-camera proxy contrastive loss function based on the global feature;
Step 4: constructing an adaptive weight for the cross-camera proxy contrastive loss based on the cross-camera proxy contrastive loss function;
Step 5: training the convolutional neural network with adaptive weight-integrated cross-camera proxy contrastive loss, and optimizing the convolutional neural network by back-propagating an optimized network parameter;
wherein step 4 comprises:
constructing an adaptive weight for dynamically adjusting the cross-camera proxy contrastive loss, an expression of the adaptive weight being given below:
$${w}_{ij} = \frac{1}{1 + exp ( - α ( \frac{{c}_{j} {f}_{i}^{g}}{‖ {c}_{j} ‖ ‖ {f}_{i}^{g} ‖} - β ) )} ;$$
where
$$\frac{{c}_{j} {f}_{i}^{g}}{‖ {c}_{j} ‖ ‖ {f}_{i}^{g} ‖}$$
represents computation of a cosine similarity for measuring a similarity between the global feature
$${f}_{i}^{g}$$
and the camera centroid cⱼ, a higher value of which indicates a higher sample-centroid similarity; α denotes a temperature parameter for controlling a degree of influence of the similarity on the weight; threshold β denotes an offset amount, which serves to adjust a similarity threshold; finally, a Sigmoid function is applied to ensure that the weight wᵢⱼ falls between (0, 1);
and step 5 comprises:
integrating the adaptive weight into the cross-camera proxy contrastive loss, expressed as:
$${L}_{final} = {\sum }_{i = 1}^{{N}_{D}} \frac{1}{\vert {P}_{i} \vert} \sum j ∈ {p}_{i} {w}_{ij} \cdot ( - log \frac{exp ( {c}_{j}^{T} {f}_{i}^{g} / τ )}{\sum k ∈ {P}_{i} ⋃ {Q}_{i} exp ( {c}_{k}^{T} {f}_{i}^{g} / τ )} ) ;$$
where N_{D} denotes the number of images; Pᵢ and Qᵢ denote sets of indexes for positive samples and hard negative samples of global feature
$${f}_{i}^{g} ,$$
respectively; wᵢⱼ denotes the weight;
$${c}_{j}^{T}$$
denotes transposition of the feature centroid of a camera-aware proxy associated with the positive sample j; τ denotes the temperature parameter;
$${c}_{k}^{T}$$
denotes transposition of the feature centroid of the camera-aware proxy.

2. The method according to claim 1, wherein step 1 comprises:
letting
$$D = {\{ {x}_{i} \}}_{i = 1}^{{N}_{D}}$$
formally represent an unlabeled training dataset, where xᵢ denotes an image and N_{D} denotes the number of images; firstly extracting a feature map represented by F_{θ}(xᵢ)∈ [symbol] ^{C×H×W}, where C, H, and W denote channel size, height, and width of the feature map, respectively; and pre-processing the person image dataset captured, the pre-processing including horizontal flipping, filling, and then cropping.

3. The method according to claim 1, wherein step 2 comprises:
firstly transmitting the pre-processed training dataset to the convolutional neural network, the convolutional neural network comprising a plurality of convolutional layers, activation layers, pooling layers, and fully connected layers;
wherein in the convolutional layers, the network extracts local features in the image by sliding a convolutional kernel to capture visual information of different patches; nonlinearity is added by applying a nonlinear activation function to an output of each convolutional layer operation, thereby enhancing model expressive power; next, in the pooling layers, the network is further down-sampled to reduce dimensions of the feature map, thereby decreasing computation and controlling overfitting; a resulting feature map from multi-layer convolution and pooling operations is flattened into a one-dimension vector and inputted into the fully connected layers to further integrate respective pieces of feature information; a feature vector outputted from the last one of the fully connected layers is a global feature
$${f}_{i}^{g} ,$$
the global feature representing global information of the input image, available for a subsequent person re-identification task.

4. The method according to claim 1, wherein step 3 comprises:
firstly performing cluster analysis on each sample feature in the training dataset and grouping similar features into a same group; obtaining centroid c_{(a,b)} of each group by computing a mean value of all features in the group; then, computing the cross-camera proxy contrastive loss based on the centroids to yield an optimized model, as expressed below:
$${ℒ}_{c a m} = - {\sum }_{i = 1}^{{N}_{D}} \frac{1}{\vert {P}_{i} \vert} \sum j ∈ {p}_{i} log \frac{exp ( {c}_{j}^{T} {f}_{i}^{g} / τ )}{\sum k ∈ {P}_{i} ∪ {Q}_{i} exp ( {c}_{k}^{T} {f}_{i}^{g} / τ )} ;$$
where Pᵢ and Qᵢ denote sets of indexes for positive samples and hard negative samples of the global feature
$${f}_{i}^{g} ,$$
respectively;
$${c}_{j}^{T}$$
denotes transposition of feature centroid of a camera-aware proxy associated with the positive sample j, which represents a mean value of the features in a same group b under a same camera label a;
$${c}_{k}^{T}$$
denotes transposition of the feature centroid of the camera-aware proxy, which represents a centroid associated with the negative sample k; τ denotes a temperature parameter for controlling a smoothness degree in loss computation.

5. A computer-readable storage medium, comprising a program stored thereon, wherein the program, when being executed, controls the computer-readable storage medium to perform the method for constructing adaptive weight-based cross-camera proxy contrastive loss according to claim 1.

6. A computer-readable storage medium, comprising a program stored thereon, wherein the program, when being executed, controls the computer-readable storage medium to perform the method for constructing adaptive weight-based cross-camera proxy contrastive loss according to claim 2.

7. A computer-readable storage medium, comprising a program stored thereon, wherein the program, when being executed, controls the computer-readable storage medium to perform the method for constructing adaptive weight-based cross-camera proxy contrastive loss according to claim 3.

8. A computer-readable storage medium, comprising a program stored thereon, wherein the program, when being executed, controls the computer-readable storage medium to perform the method for constructing adaptive weight-based cross-camera proxy contrastive loss according to claim 4.

9. An electronic device, comprising: one or more processors; a memory; and one or more computer programs, wherein the one or more computer programs are stored on the memory; the one or more computer programs include an instruction which, when being executed by the electronic device, enables the electronic device to perform the method for constructing adaptive weight-based cross-camera proxy contrastive loss according to claim 1.

10. An electronic device, comprising: one or more processors; a memory; and one or more computer programs, wherein the one or more computer programs are stored on the memory; the one or more computer programs include an instruction which, when being executed by the electronic device, enables the electronic device to perform the method for constructing adaptive weight-based cross-camera proxy contrastive loss according to claim 2.

11. An electronic device, comprising: one or more processors; a memory; and one or more computer programs, wherein the one or more computer programs are stored on the memory; the one or more computer programs include an instruction which, when being executed by the electronic device, enables the electronic device to perform the method for constructing adaptive weight-based cross-camera proxy contrastive loss according to claim 3.

12. An electronic device, comprising: one or more processors; a memory; and one or more computer programs, wherein the one or more computer programs are stored on the memory; the one or more computer programs include an instruction which, when being executed by the electronic device, enables the electronic device to perform the method for constructing adaptive weight-based cross-camera proxy contrastive loss according to claim 4.
